(19) United States
(12) Patent Application Publication
(10) Pub. No.: US 2005/0106444 A1
(43) Pub. Date: May 19, 2005

(54) Fuel cell and separator for cooling used therein

(76) Inventors: Hiroshi Yamauchi, Hitachi (JP); Kenji Yamaga, Hitachi (JP); Ko Takahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/785,984

(22) Filed: Feb. 26, 2004

(30) Foreign Application Priority Data
Nov. 19, 2003 (JP) 2003-389166

(51) Int. Cl. H01M 2/08; H01M 8/04; H01M 4/96; H01M 4/94

(52) U.S. Cl. 429/35; 429/26; 429/44; 429/34

(57) ABSTRACT

It is an object of the present invention to reduce contact resistance of a fuel cell cooling section of stamped metal and thereby to improve output capacity of the fuel cell. The present invention provides a fuel cell having a stack structure of several unit cells, each containing electrolyte membrane electrodes, gas diffusion layer provided on each side of the electrode and metallic separator having corrugated passages and coming into contact with each gas diffusion layer, and a separator for cooling provided in the stack structure, wherein the separator for cooling is provided with an elastic and/or compressive and electroconductive intermediate sheet held between the passage planes, and a gasket in the portion other than the passage plane.

### FIELD OF THE INVENTION

The present invention relates to a proton-exchange membrane fuel cell (PEMFC) and separator (bipolar plate) for cooling used therein.

### BACKGROUND OF THE INVENTION

A fuel cell has a structure in which more than tens cell units each comprising a set of components, e.g., separator, gas diffusion layer and membrane electrode assembly (MEA), are stacked. As such, it is essential to minimize contact resistance between the components for high cell efficiency.

FIG. 7 presents a cross-sectional view of a cooling section of a conventional unit with stamped metal separators coming into contact with each other. A set of two stamped metal separators 1 facing each other provides spaces in-between, which work cooling water passage grooves, where the separators come into contact with each other in a line or at a point at each of the groove apexes, which are not flat. Such a structure increases contact resistance between these parts, making it difficult to realize high power generation capacity. JP-A-2003-173791 discloses a structure in which an apex having a radius is partly cut off to be flat, in order to solve the above problem. JP-A-2003-123801, on the other hand, discloses a structure with an electroconductive sheet gasket in the interface between the separator sheets to prevent voltage drop resulting from contact resistance on the cooling water surface between these sheets.

### SUMMARY OF THE INVENTION

There are various types of fuel cells. A proton-exchange membrane fuel cell is mainly characterized by its structure with a carbon electrode impregnated with a catalyst, e.g., platinum, bonded to each side of a solid electrolyte membrane of polymer. This structure is referred to as membrane electrode assembly (MEA). A proton-exchange membrane fuel cell includes a separator which comprises a pair of sheets forming passages in-between for a fuel gas (including hydrogen) and oxidizing agent (oxygen or air), where an MEA is held between these sheets. This represents a unit cell, and the fuel cell stack is a laminate of several unit cells. The separator is responsible for supplying the reactive gas (generic term for fuel gas and oxidizing agent) efficiently towards the electrodes. An electric power can be generated by applying an adequate load to a fuel cell supplied with the reactive gas. This is accompanied by generation of the reaction heat and joule heat. To remove these heats, the separator has a section for passing cooling water to form a separator for cooling.

A separator for cooling is also responsible for reducing energy loss between adjacent cells to efficiently transfer electric power generated. Therefore, it is normally composed of a carbon-based electroconductive material. Use of a thin metallic sheet is also under study, because metals have many advantages, e.g., low raw material cost, and being easily stamped and serviceable in a thin sheet to decrease size and weight of the separator.

When a metal to be used for a separator is stamped to provide passage grooves, each groove tends to have a radius at the apex. The passage groove apex is preferably as flat as possible for the separator to transfer electric power efficiently. However, a stamped thin metallic sheet tends to have a radius at the apex, because the passage grooves are arranged at narrow pitches. As a result, a separator for cooling involves problems of increased electric resistance and voltage drop, when it has a structure with separators directly coming into contact with each other.

The separators should come into contact with each other via an interface plane of adequate area to minimize voltage drop resulting from contact resistance at the plane. In the case of a separator with a metallic sheet corrugated by stamping, the corrugated sheet apex is difficult to be flattened due to plastic forming limitation of the metallic material and tends to have a certain radius. JP-A-2003-173791 discloses a structure in which the apex is partly cut off to be flat. However, a metallic material tends to provide a point or line contact, even when a flat portion is provided, because of its high rigidity. JP-A-2003-123801 discloses a structure with an electroconductive sheet gasket in the interface between the separator sheets to prevent voltage drop. However, an electroconductive sheet gasket is not applicable to a metallic separator having passages provided between thin, stamped sheets, because the passage plane has a height different from that of the periphery on which the gasket is placed.

It is an object of the present invention to provide a means for easily, efficiently reducing contact resistance between separators of thin, stamped, metallic sheets, in particular for cooling of a fuel cell. A metallic separator may have a passive film growing gradually on its surfaces as the fuel cell generates electric power. It is another object of the present invention to provide a means for preventing growth of the passive film and hence increased resistance.

The present invention relates to a fuel cell comprising a pair of metallic separators at least one of which has corrugated passages, an intermediate held between the passage planes in the separator and a gasket, wherein the intermediate is elastic and/or compressive and electroconductive, and the gasket is provided in a portion other than the passage planes.

The present invention also provides a fuel cell having a stack structure of several unit cells, each comprising electrolyte membrane electrodes, gas diffusion layer provided on each side of the electrode and metallic separator having corrugated passages and coming into contact with each gas diffusion layer, and a separator for cooling provided in the stack structure, wherein the separator for cooling is provided with an elastic and/or compressive and electroconductive intermediate sheet held between the passage planes, and a gasket in the portion other than on the passage plane.

The first embodiment of the present invention is a metallic separator for fuel cell cooling having corrugated passages, wherein an elastic and/or compressive and electroconductive intermediate sheet is held between the passage planes of the separator for cooling and adjacent one, and a gasket is provided in the portion other than the passage plane, to reduce contact resistance in the cooling section of the fuel cell, and a fuel cell comprising the same separator for cooling.

The second embodiment of the present invention is the separator of the first embodiment for fuel cell cooling, wherein part the intermediate sheet has openings in the portion not coming into contact with the other separator for cooling for enhanced cooling effect in addition to reduced contact resistance.

The third embodiment of the present invention is the separator of the first embodiment for fuel cell cooling, wherein the intermediate sheet is of at least one material selected from the group consisting of carbon paper, carbon cloth, graphite sheet, expanded metal, electroconductive rubber and electroconductive resin to realize reduced contact resistance.

The fourth embodiment of the present invention is the separator of the first embodiment for fuel cell cooling which is coated, at least on the plane coming into contact with the intermediate sheet, with an electroconductive material capable of preventing growth of an oxide film or corrosion, in order to sustain its low contact resistance effect for extended periods by preventing corrosion of the separator or growth of a passive film thereon.

The fifth embodiment of the present invention is a metal-made separator for fuel cell cooling having corrugated passages, wherein the separator is coated with a metal selected from the group consisting of niobium, tantalum, tungsten, titanium, titanium-based alloy, aluminum, aluminum-based alloy, stainless steel and nickel alloy for the outermost layer and also coated, at least on the surface passing electric current, with one selected from the group consisting of a carbon, carbon/resin mixture, plated and electroconductive ceramic layer, and an elastic and/or compressive and electroconductive intermediate sheet is held between the passage planes of the separator for cooling and adjacent one, in particular in order to reduce contact resistance and sustain its effect for extended periods.

The separator for cooling having the above characteristics permits the fuel cell in which it is assembled to produce high cell output for extended periods.

The present invention is provided with an elastic and/or compressive and electroconductive intermediate sheet between the 2 separators for cooling to secure a large contact area between them and thereby to improve power output capacity of the fuel cell.

Other objects, features and advantages of the invention will become apparent from the following description of the embodiments of the invention taken in conjunction with the accompanying drawings.

### BRIEF DESCRIPTION OF THE DRAWINGS

FIG. 1 is an oblique cross-sectional view illustrating the separator assembly for cooling of the first embodiment of the present invention.

FIG. 2 is an oblique cross-sectional view illustrating the separator assembly for cooling of another embodiment of the present invention with a pair of separators for cooling holding an intermediate sheet in-between, wherein each separator is coated with a layer on each side to prevent growth of a passive film on the separator surfaces.

FIG. 3 is a developed view illustrating components of the fuel cell of the present invention.

FIG. 4 is a developed view illustrating the separator assembly structure with gaskets for the fuel cell shown in FIG. 3.

FIG. 5 is a plan illustrating an intermediate sheet of slit-like structure.

FIG. 6 is a developed view of a pair of separators for cooling holding an intermediate sheet of slit-like structure in-between.

FIG. 7 is an oblique cross-sectional view illustrating a conventional separator for cooling with a pair of stamped metallic sheets coming into contact with each other to provide cooling medium passages in-between.

### DESCRIPTION OF THE REFERENCE NUMERALS AND SIGNS

1: Separator, 2: Intermediate, 3: Coating layer, 4: Gasket, 5: Separator with a gasket, 6: MEA, 7: Gas diffusion layer, 8: Current collecting sheet, 9: Insulator sheet, 10: End plate, 101: Manifold (separator), 102: Passage groove, 103: Flat portion, 201: Slit, 202: Lattice, 104: Rib, 401: Manifold (separator)

### DETAILED DESCRIPTION OF THE INVENTION

The present invention provides a means for reducing contact resistance between adjacent metallic separators which constitute the separator for cooling and thereby for improving cell efficiency of the fuel cell of the present invention. It also provides a means for sustaining good cell capacity for extended periods by preventing a passive film growing on the metallic separator surfaces as the cell generates electric power, for which an elastic and/or compressive and electroconductive intermediate is held between the adjacent separators for cooling.

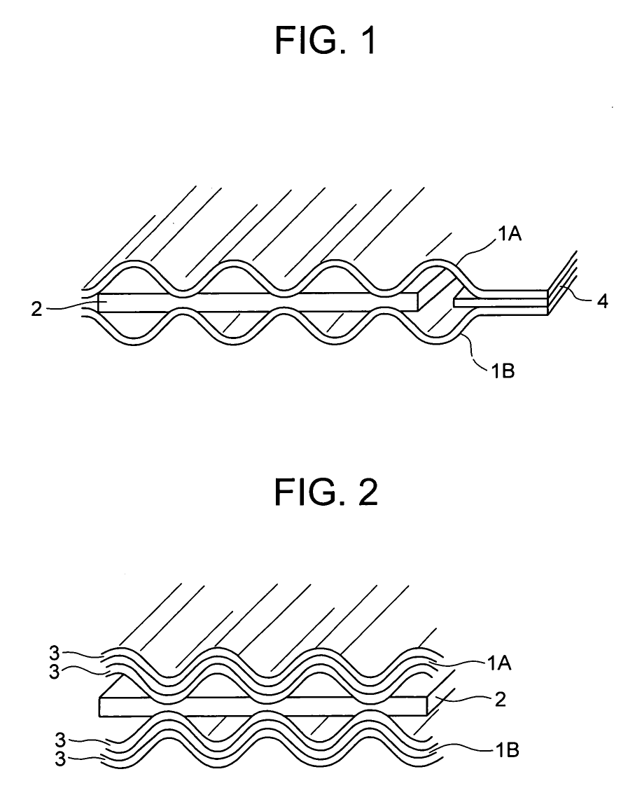

FIG. 1 shows part of the cross-section of the separator of the first embodiment of the present invention, where the separator comprises two separators 1A and 1B, each of which is made of a thin sheet stamped to be corrugated at the center, the apexes of one separator facing the corresponding ones of the other separator. These separators 1A and 1B are stamped to each other under an adequate pressure to hold an elastic and/or compressive and electroconductive intermediate in-between. They come into contact with each other via a wide area via the intermediate, which is deformed under pressure, to reduce contact resistance between them.

The cooling section formed by the two separators 1A and 1B is hereinafter referred to as the cooling cell. The cell generating electric power with the MEA 6, described later, held between these separators 1A and 1B is hereinafter referred to as the power-generating cell.

FIG. 2 shows a structure with the separators 1A and 1B holding an intermediate 2 in-between, wherein each separator is coated with the coating layer 3 on each side to prevent growth of a passive film on the separator surfaces. A metallic separator, except that of a noble metal, is spontaneously coated with a passive film, which grows to increase resistance of the separator. This film is insulating or semiconducting in nature to cause deterioration of electroconductivity of the separator as it grows. In particular, a fuel cell operates at a high temperature in the presence of moisture, providing a good atmosphere for flow of electric current, with the result that a passive film notably grows on the separator. Growth of the film can be efficiently prevented by isolating the metal from the cell operating atmosphere. The coating layer 3 covers both sides of each of the separators 1A and 1B over the entire surface, which however is not always necessary, and may cover only the portion coming in contact with the intermediate 2.

### EXAMPLES

### (Example 1)

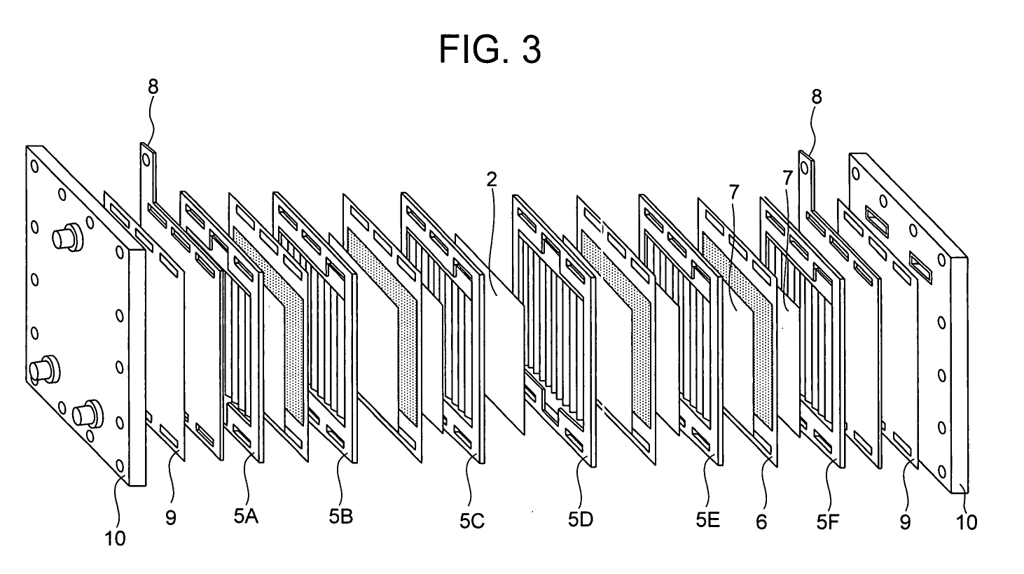

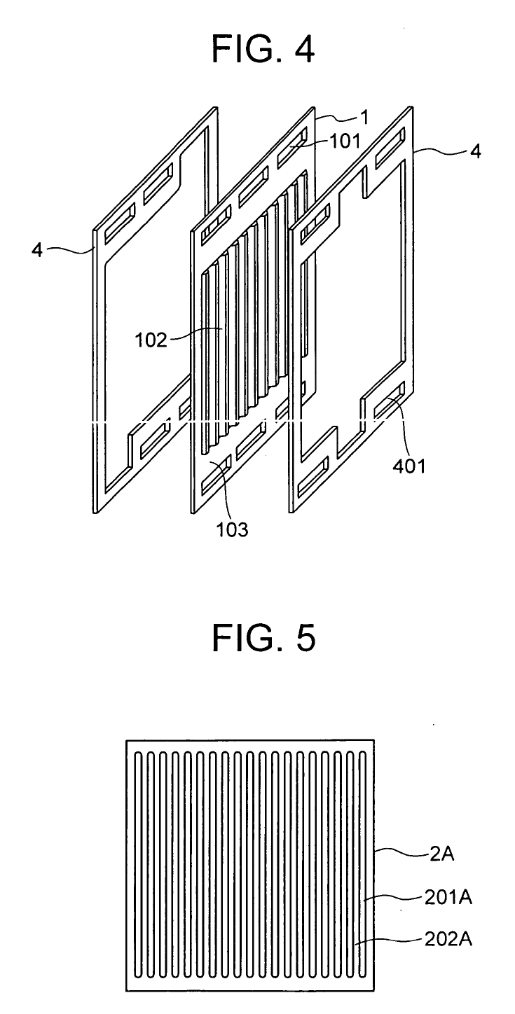

EXAMPLE 1 of the present invention is described. FIG. 3 is a developed view illustrating the fuel cell of the present invention. FIG. 4 illustrates one of the gasket-provided separator assembly structures 5A to 5F, shown in FIG. 3. First, the gasket-provided separator assembly structure 5 is described. It has a structure with the gasket 4 put on the separator 1 as the substrate. The separator 1, 160 mm by 120 mm, was made of 0.2 mm thick thin stainless steel (Type 304) (or AISI 304) overhang-stamped to have linear passage grooves at the center, where flat section 103 was provided around passage grooves as tabs for sealing. The passage groove section was 100 mm by 100 mm, and each groove was 2 mm wide (including width of the apexes) and 0.5 mm deep. The gasket 4 was put on the flat section 103, to direct cooling water (or reaction gas in the case of the power-generating cell) from the manifolds 101 provided in the separator towards the passage grooves 102. Therefore, a plurality of manifolds 101 were provided, some partly cut off. The separator 1, when provided with the gasket 4, was referred to as the gasket-provided separator 5

FIG. 3 shows the fuel cell in which the gasket-provided separator assembly 5 shown in FIG. 4 is mounted. The fuel cell of the present invention is described taking, as an example, a cell comprising 4 power-generating cells and one cooling cell. A total of 6 gasket-provided separator assemblies 5A to 5F were used to form the power-generating cells and cooling cell. The MEA 6 and gas diffusion layer 7 were held between the gasket-provided separator assemblies 5A and 5B, 5B and 5C, 5D and 5E, and 5E and 5F to form the power-generating cell. Each of the gasket-provided separator assemblies 5 was surface-treated for the portion facing the MEA 6 and gas diffusion layer 7 to prevent growth of a passive film or corrosion. In this example, it was coated with an electroconductive paint which was a mixture of phenolic binder (40% by weight), flaky graphite having an average diameter of 100 μm (50% by weight) and n-methyl-2-pyrrolidone (MMP, 10% by weight), as one of the representative means for surface treatment. It was heat-treated to form the electroconductive coating layer.

The MEA 6, 160 mm by 120 mm and 0.05 mm thick, comprises an electrolyte membrane of perfluorosulfonic acid on which carbon black impregnated with platinum at 40% by weight was spread over an area having the same size as the passage grooves in the separator to have a platinum density of 0.4 mg/cm². The manifolds were provided for supplying and discharging the reaction gas and cooling water.

The cooling cell was formed by placing the intermediate 2 between the gasket-provided separator assemblies 5C and 5D. The current-collecting plate 8 for collecting electric power, insulator plate 9 and end plate 10 were provided on the outer side of each of the gasket-provided separator assemblies 5A and 5F. The two end plates 10 were fastened together by, e.g., bolts and nuts (not shown) to complete the fuel cell. It is necessary to deform the intermediate 2 by an adequate compressive pressure. The preferable materials which show the deformation characteristics include elastomers represented by electroconductive rubber, and compressive materials, e.g., carbon paper and cloth. Formed metals, e.g., of stainless steel and nickel may be also used. When 0.2 mm thick carbon paper, for example, is used as the intermediate 2, it will show a compressive deformation to lose the thickness by around 10% on the place coming into contact with the separator 1 at 10 kg/cm², a clamping pressure adopted for forming the cell in EXAMPLE 1. This almost doubled the contact area, as determined by a pressure-sensitive paper. Adequate hardness of the intermediate 2 is several to several tens kgf/cm² in terms of coefficient of elasticity.

The MEA 6 provided in each of the 4 power-generating cells was supplied on both sides with a fuel gas and oxidizing agent independently via the manifolds in the gasket-provided separator 5 and the MEA 6, when these gases were introduced through the reaction gas inlet ports in the end plates 10. As a result, an electromotive force was produced between the electrodes in the MEA 6 to generate electric power, when an adequate load was applied to between the current-collecting plates.

Cooling water was supplied in a similar manner from the end plates 10 to the space formed between the gasket-provided separator assemblies 5C and 5E via the manifold, to remove heat generated as power was produced.

### (Example 2)

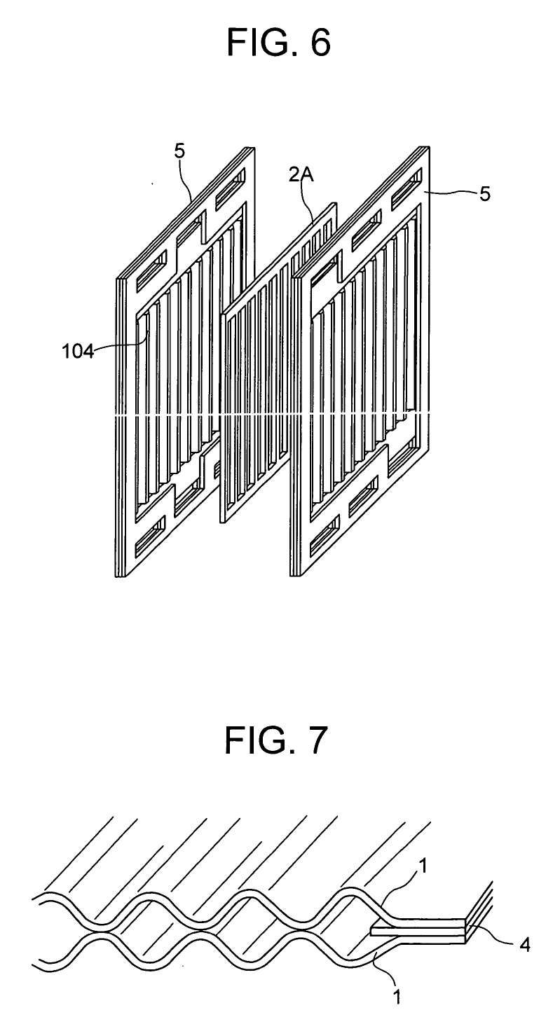

The intermediate 2 described in EXAMPLE 1 was a flat plate. It may be replaced by the slit-structured intermediate 2A, which is the intermediate 2 whose portion not contacting with the separator 1 is removed. FIG. 5 is a plan illustrating the slit-structured intermediate 2A, and FIG. 6 the intermediate 2A assembled in a cooling cell. The intermediate 2A was machined by an adequate means, e.g., punching, to have a plurality of the slits 201A by removing the portions not contacting with the separator 1, as shown in FIG. 5. It was held by a pair of the gasket-provided separators 5 in such a way that the rib apex in the gasket-provided separator assembly 5 comes into contact with the corresponding lattice 202A in the intermediate 2.

Use of the intermediate 2A can increase cooling water passage cross-section, thereby reducing pressure loss resulting from flow of water, with the result that the fuel cell has enhanced efficiency. The intermediate 2 described in EXAMPLE 1 divided the space as the cooling water passage, formed by the gasket-provided separator assemblies 5C and 5D, and might cause varying cooling effect because the cooling water flowed differently in the divided spaces. On the other hand, use of the intermediate 2A shown in FIG. 5 can prevent varying cooling effect. Moreover, the adjacent power-generating cells with the cooling cell in-between may produce different heat. The intermediate cell, which does not divide the cooling cell, can secure a uniform cooling effect.

### (Example 3)

In EXAMPLE 3, power generation by the fuel cell prepared in EXAMPLE 1 is described, where a load was applied to the fuel cell by an electronic loading device. An optional load can be applied to the fuel cell by connecting the electronic loading device to the 2 current-collecting plates in the fuel cell to pass a given current between them. The fuel gas and oxidizing agent supplied to the fuel cell were pure hydrogen and air. They were passed through a humidifier beforehand to have a given dew point. Temperature of the cooling water was controlled at the inlet port, at which the fuel cell operated at a constant temperature.

The power was generated under the following conditions, hydrogen utilization: 80%, oxygen utilization: 40%, fuel gas dew point: 60° C., oxidizing agent dew point: 50° C. and cell temperature: 70° C., where a load was applied to the cell after temperature and flow rate became steady. The power was generated at a constant rate for 24 hours at a current density of 0.25 A/cm², where cell voltage was 2.8V after it became steady, or 0.71V as the average for one cell. The AC resistance was 6.5 mΩ.cm², determined by the 4-terminal method after the load was stopped.

The cell voltage and AC resistance were measured under the same conditions in the absence of the intermediate 2. The cell voltage was 2.6V, or 0.67V as the average for one cell. Thus, contact resistance was decreased in the presence of the intermediate 2, resulting in increased cell voltage.

### (Example 4)

Cell voltage gradually decreased with time as the fuel cell generated electric power, whether the intermediate cell 2, described in EXAMPLE 2, was present or not. For example, cell voltage decreased by 0.2 to 0.3V in each case for 150 hours after power generation was started. Decreased voltage and increased AC resistance were particularly noted in the cooling cell section, indicating that voltage drop resulted from that in the cooling cell section. It was found that voltage drop was almost controlled when the separator 1 in the cooling cell was coated with the coating layer 3, shown in FIG. 2. The coating layer 3 was formed by a means similar to that for forming the gasket-provided separator 5 in the power-generating cell, described in EXAMPLE 1. It is not limited, however, so long as it is electroconductive and has a function of preventing corrosion of the separator 1 surface as the base or preventing growth of a passive film on the surface. A mixed paint of phenolic binder and graphite was spread to form the coating layer 3 in EXAMPLE 4. However, plated gold or electroconductive ceramic coating can exhibit the desired effect. However, the coating layer 3 in EXAMPLE 4 is preferable, because it has a limited number of pinholes and can be formed by a simple process. Of electroconductive paints, a mixture of fluorine-based resin as a binder and carbon black or graphite as an electroconductive agent exhibits the desired characteristics for protecting the base metal and keeping electroconductivity, because of very low water-permeability of the resin.

An electroconductive paint, e.g., a mixed paint of phenolic binder and graphite used in EXAMPLE 4, was found to control resistance increase by 10 mΩ.cm² or less and voltage drop by 3 mV or less in the cooling cell section for 1000 hours after the power generation was started.

The separator 1 used in EXAMPLE 4 was made of a corrosion-resistant alloy, e.g., stainless steel (e.g., Type 304). However, it represents only one example, and the material is not limited so long as it is a corrosion-resistant metal. The particularly preferable metals include niobium, tantalum, tungsten, titanium, titanium-based alloy, aluminum, aluminum-based alloy, stainless steel and nickel alloy.

These metals are particularly preferable because of their high corrosion resistance at 70° C. in warm water. Some of other metals, e.g., iron and copper, are not desirable because they are easily corroded at 70° C. in warm water to massively release the metallic ions, which may accelerate deterioration of MEA 6. Not a few pinholes, cracks or voids will be formed in these metals for the coating layer 3 of any type to leak corrosion products from the separator 1, when it is easily corroded.

On the other hand, a passive film will grow rapidly even on a corrosion-resistant metal when it is unprotected. It is therefore preferably coated with the coating layer 3 selected from the group consisting of a carbon, carbon/resin mixture, plated and electroconductive ceramic layer to be protected from the ambient atmosphere. This should control growth of a passive film. It is not always necessary to coat the entire surface of the separator with the layer 3. Only the portion through which electric current flows, i.e., the portion of the separator 1 coming into contact with the intermediate 2, may be coated to save the material for the coating layer 3. This will bring a large economic effect.

EXAMPLES have described some of the embodiments of the present invention. However, the present invention is not limited to the above, so long as it includes a metallic separator for cooling which has a structure with an elastic and/or compressive and electroconductive intermediate sheet. The cooling cell section described in EXAMPLES has a pair of corrugated separators 1 facing each other. However, it may be of a structure with one corrugated separator combined with a flat separator. Carbon paper was used as one of the representative materials for the intermediate 2. However, the similar effect can be produced when it is of an elastic or compressive material, e.g., carbon cloth, expanded metal, electroconductive rubber or electroconductive resin. Of these materials, carbon paper and cloth are more preferable viewed from electroconductivity or corrosion resistance.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell comprising a pair of metallic separators at least one of which has corrugated passages; an intermediate held between the passage planes in the separator; and a gasket; wherein the intermediate is elastic and/or compressive, and electroconductive; and the gasket is provided in a portion other than the passage planes.

2. A fuel cell having a stack structure of several unit cells, each comprising electrolyte membrane electrodes, gas diffusion layer provided on each side of the electrode and metallic separator having corrugated passages and coming into contact with each gas diffusion layer, and a separator for cooling provided in the stack structure, wherein the separator for cooling is provided with an elastic and/or compressive and electroconductive intermediate sheet held between the passage planes, and a gasket in the portion other than the passage plane.

3. The fuel cell according to claim 2, wherein part of said intermediate sheet has openings in the portion not coming into contact with said separator for cooling.

4. The fuel cell according to claim 2, wherein said intermediate sheet is of at least one material selected from the group consisting of carbon paper, carbon cloth, graphite sheet, expanded metal, electroconductive rubber and electroconductive resin.

5. The fuel cell according to claim 2, wherein said separator for cooling is coated, at least on the plane coming into contact with said intermediate sheet, with an electroconductive material capable of preventing growth of an oxide film on, or corrosion of, said separator for cooling.

6. A fuel cell having a stack structure of several unit cells, each comprising electrolyte membrane electrodes, gas diffusion layer provided on each side of the electrode and metallic separator having corrugated passages and coming into contact with each gas diffusion layer, and a separator for cooling provided in the stack structure, wherein the separator for cooling is coated with a metal selected from the group consisting of niobium, tantalum, tungsten, titanium, titanium-based alloy, aluminum, aluminum-based alloy, stainless steel and nickel alloy for the outermost layer and also coated, at least on the surface passing electric current, with one selected from the group consisting of a carbon, carbon/resin mixture, plated and electroconductive ceramic layer, and an elastic and/or compressive and electroconductive intermediate sheet is held between the passage planes of the separator for cooling and adjacent one.

7. A separator for fuel cell cooling comprising a pair of metallic separators for cooling which have corrugated passages, wherein an elastic and/or compressive and electroconductive intermediate sheet is held between the passage planes, and a gasket is provided in the portion other than the passage plane.

8. The separator for fuel cell cooling according to claim 7, wherein part of said intermediate sheet has openings in the portion not coming into contact with said separator for cooling.

9. The separator for fuel cell cooling according to claim 7, wherein said intermediate sheet is of at least one material selected from the group consisting of carbon paper, carbon cloth, graphite sheet, expanded metal, electroconductive rubber and electroconductive resin.

10. The separator for fuel cell cooling according to claim 7 which is coated, at least on the plane coming into contact with said intermediate sheet, with an electroconductive material capable of preventing growth of an oxide film on, or corrosion of, said separator for cooling.

11. A separator for fuel cell cooling comprising a pair of metallic separators for cooling at least one of which has corrugated passages, wherein an elastic and/or compressive and electroconductive intermediate sheet is held between the passage planes of the separator for cooling and adjacent one, and the separator for cooling is coated with a metal selected from the group consisting of niobium, tantalum, tungsten, titanium, titanium-based alloy, aluminum, aluminum-based alloy, stainless steel and nickel alloy for the outermost layer and also coated, at least on the surface passing electric current, with one selected from the group consisting of a carbon, carbon/resin mixture, plated and electroconductive ceramic layer.
